(19) United States
(12) Patent Application Publication
(10) Pub. No.: US 2004/0070076 A1
(43) Pub. Date: Apr. 15, 2004

(54) Semiconductor chip package for image sensor and method of the same

(76) Inventors: Yoshiaki Hayashimoto, Kanagawa-ku (JP); Young-Joo Seo, Wonmi-ku (KR)

Correspondence Address: Michael A. Cantor, 55 Griffin South Road, Bloomfield, CT, 06002, US

(21) Appl. No.: 10/300,034

(22) Filed: Nov. 19, 2002

(30) Foreign Application Priority Data
Oct. 11, 2002 (KR) 2002-62125

(51) Int. Cl. F16K 35/00

(52) U.S. Cl. 257/749; 251/100; 257/678

(57) ABSTRACT

An semiconductor chip package for image sensor includes an semiconductor chip for image sensor, a base member with a groove to that the semiconductor chip is mounted therein, a lead formed through the base member and spaced apart from the semiconductor chip, a conductive connecting member for electric connection between the lead and the semiconductor chip, and a transparent seal material formed in the groove for sealing the semiconductor chip for image sensor and the conductive connecting member, wherein an upper surface of the seal material is parallel with an upper surface of the semiconductor chip.

### BACKGROUND OF THE INVENTION

1. Field of the Invention

This invention relates to a semiconductor chip package. More particularly, this invention relates to a semiconductor chip package for image sensor.

2. Description of the Related Art

An image sensor is a device for converting perceived optical information of a subject into electrical signals. And the image sensor consists of a pickup tube and a solid-state image-sensing device; the former includes vidicon, plumbicon and the like and the latter includes CMOS, CCD and the like.

Of these image sensors, image sensor containing a solid-state image-sensing device is usually used in the form of a semiconductor chip package having a semiconductor chip for image sensor in combined with a lens.

FIG. 1 shows a cross-sectional view of a semiconductor chip package for image sensor according to a conventional technique. The reference numeral 1 indicates a base member, 3 indicates an image sensor chip, 4 indicates a lead, 5 indicates conductive connecting member, 6 indicates glass lid, 7 indicates an electrode pad and 8 indicates seal material.

Referring to FIG. 1, the conventional image sensor package includes an image sensor chip 3, a base member with a pre-molded groove in which the image sensor chip 3 is mounted. Also the image sensor chip 3 has a plurality of an electrode pad 7 for electric connection with the external circuits, which is connected with a lead 4 through a conductive connecting member 5. A glass lid 6 is mounted on the base member 1 and sealed to protect the image sensor chip 3 and the conductive connecting member 5.

Meanwhile, In case of the conventional image sensor package, the glass lid 6 needs to be close to the zero in surface irregularity and not to contain an air bubble.

The glass lid 6 is sealed with the base member 1 and a seal material 8, but it is very difficult to maintain the same surface irregularity after curing the seal material 8. Moreover, as one factor in defective production is a stain such as a fingerprint left on the glass lid 6, the image sensor needs to be handled with care and the image sensor is high in cost.

Also, since it is necessary to separate the conductive connecting member 5 with the glass lid 6 apart in order not to contact with each other and the glass lid 6 needs to have an enough thickness to prevent the external impact damage, it is impossible to make a package thickness below a particular value.

To solve this problem, a Korean patent publication No. 2002-66642 discloses a package having entire package body as well as base member made of transparent resin. According to the above invention, entire package body is sealed with a transparent resin instead of using a base member made of ceramic material. Compared with ceramic material, the transparent resin is less expensive and softer. Therefore, it has an advantage in production cost, but it is high defective proportion due to a scratch on a resin surface.

### SUMMARY OF THE INVENTION

The present invention is designed to solve the problems of the prior art, and therefore an object of the present invention is to provide an image sensor package that is simple to manufacture, low in cost and easy to handle.

This object, other incidental ends and advantages of the invention will hereinafter appear in the progress of the disclosure and as pointed out in the appended claims.

In order to accomplish the above object, the present invention provides a semiconductor chip package for image sensor comprising a semiconductor chip for image sensor, a base member with a groove to that the semiconductor chip is mounted therein, a lead formed through the base member and spaced apart from the semiconductor chip, a conductive connecting member for electric connection between the lead and the semiconductor chip, and a transparent seal material formed in the groove for sealing the semiconductor chip for image sensor and the conductive connecting member, wherein an upper surface of the seal material is parallel with an upper surface of the semiconductor chip.

Also, the present invention provides a method of packaging image sensor comprising (a) mounting a semiconductor chip for image sensor in a groove of a base member to attach, (b) electrically connecting the semiconductor chip with a lead formed through the base member using a conductive connecting member, (c) dropping a transparent seal material on a upper surface of the semiconductor chip, (d) applying high-speed rotation force on a surface of the seal material so that the dropped seal material is filled up in the groove to be in parallel with the semiconductor chip, and (e) curing the seal material.

In another embodiment, the present invention provides a semiconductor chip package for an image sensor comprising a substrate formed a predetermined circuit pattern therein, a semiconductor chip for an image sensor mounted on the substrate, a conductive connecting member for electric connection between the substrate and the semiconductor chip, and a transparent seal material integrated on an upper portion of the substrate for wrapping and sealing the semiconductor chip for image sensor and the conductive connecting member, wherein an upper surface of the seal material is parallel with an upper surface of the semiconductor chip.

Also the present invention provides a method of packaging image sensor comprising (a) mounting a semiconductor chip for image sensor on a substrate formed a predetermined circuit pattern to attach, (b) electrically connecting the semiconductor chip with the substrate using a conductive connecting member, (c) applying a inner seal material for wrapping all around the semiconductor chip and an exterior of the conductive connecting member, (d) dropping a transparent seal material on a upper surface of the image sensor chip, (e) applying high-speed rotation force on a surface of the seal material so that the dropped seal material is filled up in the inner seal material to be in parallel with the image sensor chip, and (f) curing the inner seal material and the seal material therein.

Any kind of transparent resin is available for the above transparent seal material, but it is preferable that the transparent seal material is one selected from the group consisting of silicon resin, epoxy resin and acryl resin.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a cross-sectional view of a conventional semiconductor chip package for image sensor;

FIG. 2 is a cross-sectional view of a semiconductor chip package for image sensor in accordance with a preferred embodiment of the present invention;

FIGS. 3a to 3d is a flow of manufacturing a semiconductor chip package for image sensor in accordance with a preferred embodiment of the present invention;

FIG. 4 is a cross-sectional view of a semiconductor chip package for image sensor in accordance with another preferred embodiment of the present invention;

FIGS. 5a to 5c is a flow of manufacturing a semiconductor chip package for image sensor in accordance with another preferred embodiment of the present invention; and

FIG. 6 is a cross-sectional view of a compact camera with a semiconductor chip package for image sensor in accordance with a preferred embodiment of the present invention.

### DETAILED DESCRIPTION OF THE PREFERRED EMBODIMENT

Hereinafter, preferred embodiments of the present invention will be described in detail with reference to the accompanying drawings.

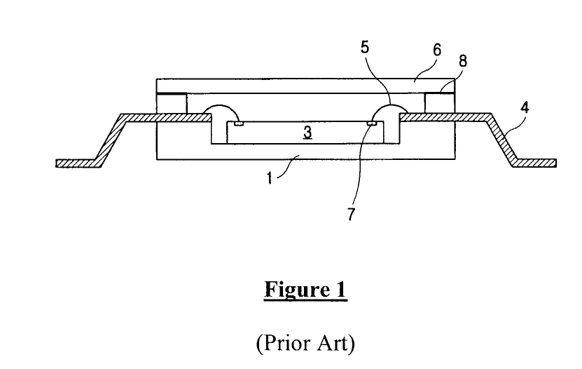

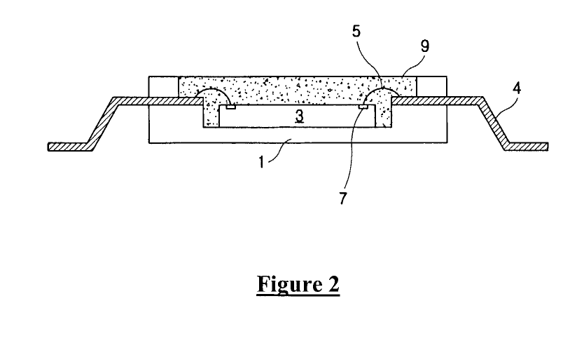

FIG. 2 shows a cross-sectional view of a semiconductor chip package for image sensor in accordance with a preferred embodiment of the present invention. The same reference numerals that shown in FIG. 1 indicate the same members as carry out the same function.

Referring to FIG. 2, an image sensor package in present invention includes an image sensor chip 3 and a base member 1 having a pre-molded groove in which the image sensor chip 3 is mounted.

A lead 4 is formed through the base member 1 and spaced apart from the image sensor chip 3. Also the image sensor chip 3 has a plurality of an electrode pad 7 for electric connection to an external circuit and the electrode pad 7 and the lead 4 is electrically connected through a conductive connecting member 5.

In the present invention, a seal material 9 instead of a glass lid is used for protecting the image sensor chip 3, which is fully filled up the groove in which the image sensor chip 3 is mounted to seal the image sensor chip 3 and the conductive connecting member 5.

While it is necessary to leave spaces to such an extent that the glass lid does not contact with the conductive connecting member in case of a conventional image sensor package, it is possible to reduce a thickness of an image sensor chip in the present invention because the seal material 9 is filled up the groove to contact with the conductive connecting member 5 in the present invention.

Meanwhile, the seal material 9 needs to be transparent and an upper surface of that is even and parallel with that of the image sensor chip 3, which makes a light not refracted during light transmittance finally to inhibit the picture signal distorted.

Any kinds of transparent resin are available for the seal material 9, but preferably, one of silicon resin, epoxy resin and acryl resin is used.

As the base member 1, ceramic material in high price is generally used. Because a ceramic substrate has a characteristic of an insulating material, there is no short-circuit even if a conductive member is mounted in a hole that formed in the ceramic substrate. Hence, in using the ceramic substrate, it is unnecessary to perform a coating process to coat a substrate with an insulating material. But, it has a poor heat release and a high brittleness so that it is easy to be broken. To solve this shortcoming a lead frame molded out of compound or plastics is used for a base member of an image sensor package, but it is not widely used due to a difficulty in assembling process and a poor clearness caused by adsorption.

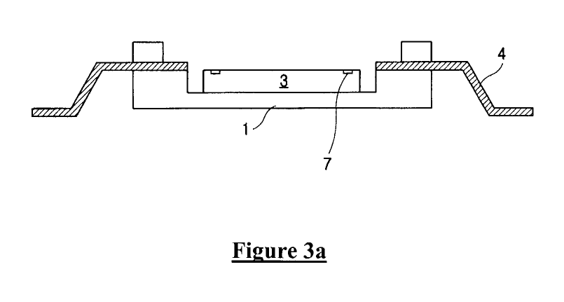

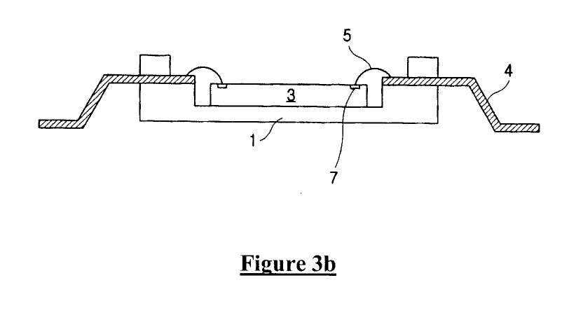

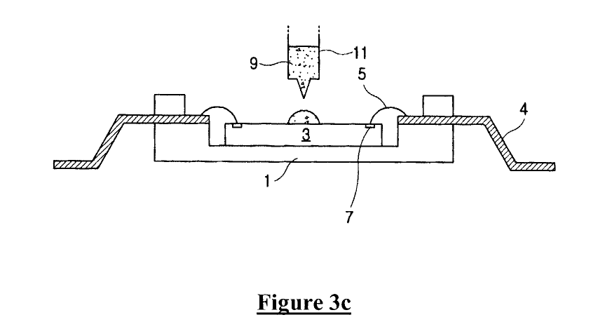

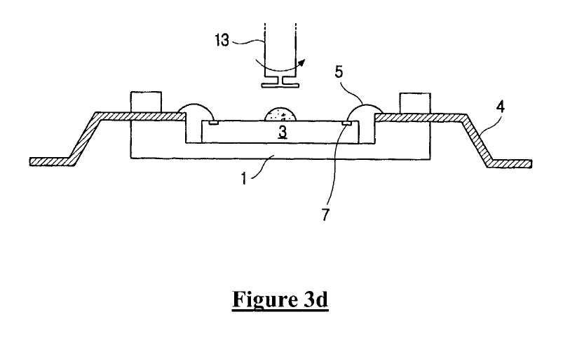

FIGS. 3a to 3d shows a flow of manufacturing a semiconductor chip package for image sensor in accordance with a preferred embodiment of the present invention. The same reference numerals that shown in FIG. 2 indicate the same members as carry out the same function.

As shown in FIG. 3a, a base member 1 with a pre-molded groove in which an image sensor chip 3 is mounted is prepared and image sensor chip 3 is attached to the die pad (not shown in figure) in the groove.

After the image sensor chip 3 is attached, as shown in FIG. 3b, a conductive connecting member 5 such as a wire is used to connect an electrode pad 7 of the image sensor chip to a lead 4. Here, image sensor chip 3 is connected with an external circuit.

After the conductive connecting member 5 is bonded to connect, a seal material 9 is applied in the groove to seal the image sensor chip 3. The reason that the image sensor chip is sealed is to protect from physical or chemical damage caused by an external impact or an impurity.

Now, a process of sealing the groove is described in detail.

First, a proper amount of the seal material 9 is dropped on an upper surface of an image sensor chip 3 as shown in FIG. 3c. It is preferable that any kinds of transparent resin capable of transmitting an incident light is used for the seal materials 9, but particularly one of silicon resin, epoxy resin and acryl resin is preferable. Also it is preferable that a dispenser 11 is used to drop a proper amount of the seal material 9.

When the seal material 9 is dropped, a high-speed rotation force of a spindle 13 is applied on a surface of the seal material 9 so that the seal material 9 is filled up the groove with no air bubble and the surface of the seal material 9 is kept even as shown in FIG. 3d. Here, the upper surface of the seal material 9 is needed to be in parallel with the image sensor chip 3 and be even in order to avoid a incident light refracted by irregular thickness of the seal material.

After the seal material 9 is filled up the groove, the seal material 9 is cured. At this time, a different curing method can be applied on the seal material 9 having different properties of matter.

After the above process is completed, an image sensor package is yielded. A completed image sensor package is used with a lens for an imaging device such as camera and cellular phone.

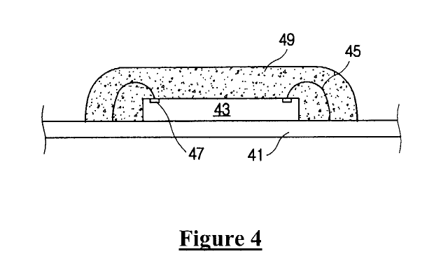

FIG. 4 shows a cross-sectional view of a semiconductor chip package for image sensor in accordance with another preferred embodiment of the present invention. The reference numeral 41 indicates a substrate, 43 indicates an image sensor chip, 45 indicates a conductive connecting member, 47 indicates electrode pad and 49 indicates a seal material.

Referring to FIG. 4, an image sensor package in this invention includes a substrate 41 formed a predetermined circuit pattern therein, a semiconductor chip 43 for an image sensor mounted on the substrate, a conductive connecting member 45 for electric connection between the substrate 41 and the semiconductor chip 43 and a transparent seal material 49 integrated on an upper portion of the substrate 41 for wrapping and sealing the semiconductor chip for image sensor and the conductive connecting member 45, wherein an upper surface of the seal material 49 is parallel with an upper surface of the semiconductor chip 43.

Silicon resin, epoxy resin and acryl resin is used for the seal material 49, and a PCB (printed circuit board) can be used for the substrate 41.

As a pre-molded base member and a glass lid are not included in this embodiment, it is possible to make an image sensor package with a thin thickness.

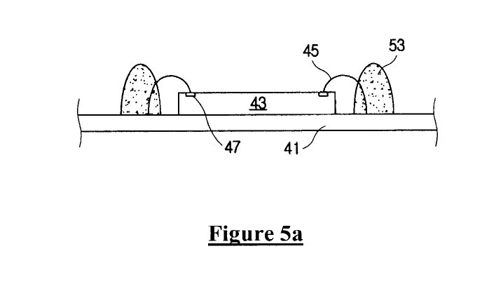

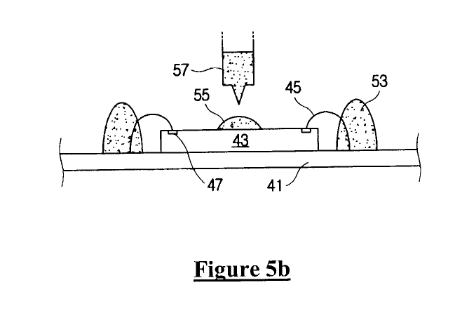

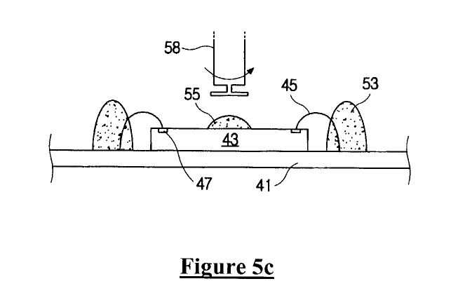

FIGS. 5a to 5c shows a flow of manufacturing a semiconductor chip package for image sensor in accordance with another preferred embodiment of the present invention. The same reference numerals that shown in FIG. 4 indicate the same members as carry out the same function. And the reference numeral 53 indicates an inner seal material and 55 indicates a seal material.

Referring to FIGS. 5a to 5c, after an image sensor chip 43 is attached to a substrate 41 formed a predetermined circuit pattern, a electrode pad 47 of image sensor chip 43 and a lead of the substrate 41 are electrically connected using a conductive connecting member 45 such as a wire. As above process is the same as the former embodiment, the details are left out.

After then, a process of sealing the image sensor chip 43 and the conductive connecting member 45 is carried out. Here, It is preferable that an inner seal material is applied all around the image sensor chip 43 and an exterior of the conductive connecting member, which prevents a flowing seal material 49 from affecting on other components. Preferably, the inner seal material 53 is the same material as a seal material 55 but requires more viscous and less curing time.

When the inner seal material 53 is formed, as shown in former embodiment, a proper amount of the seal material 55 is dropped on the inner seal material as shown in FIG. 5b. It is preferable that a dispenser 57 is used to drop a proper amount of the seal material 55. As the seal material 55 is uniformly covered all over a surface of the inner material 53 and the image sensor chip 43, it needs less viscous than the inner material 53. Preferably, one of silicon, epoxy resin and acryl resin is used as the seal material 55.

When the seal material 55 is dropped, a high-speed rotation force of a spindle 58 is applied on a surface of the seal material 55 so that an area surrounded with the inner seal material 53 is filled up as shown in FIG. 5c. Here, the upper surface of the seal material 55 is needed to be in parallel with the image sensor chip 43 and be even in order to avoid a incident light refracted by irregular thickness of the seal material.

After the seal material 55 is filled up the area surrounded with the inner material 53, the inner material 53 and the seal material 55 is cured.

After the above process is completed, the image sensor package is yielded. A completed image sensor package is used with a lens for an imaging device such as camera and cellular phone.

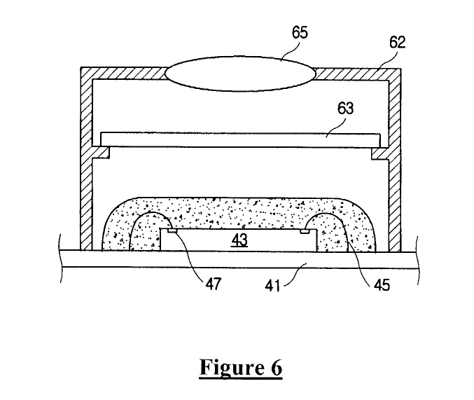

FIG. 6 shows a cross-sectional view of a compact camera with a semiconductor chip package for image sensor in accordance with a preferred embodiment of the present invention. The same reference numerals that shown in FIG. 4 indicate the same members as carry out the same function. And the reference numeral 62 indicates a lens holder, 63 indicates an infrared filter and 65 indicates a lens.

Referring to FIG. 6, a lens 65 and an infrared filter are mounded on a lens holder attached to a substrate 41. An incident light passing through the lens 65 and the infrared filter 63 is filtered off and fed into the image sensor chip 43.

An optical signal fed into the image sensor chip 43 is converted into an electric signal and finally is formed as image.

The semiconductor chip package for an image sensor and the method of the same according to the present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A semiconductor chip package for an image sensor comprising:
a semiconductor chip for an image sensor;
a base member with a groove that the semiconductor chip is mounted therein;
a lead formed through the base member and spaced apart from the semiconductor chip;
a conductive connecting member for electric connection between the lead and the semiconductor chip; and
a transparent seal material formed in the groove for sealing the semiconductor chip for image sensor and the conductive connecting member, wherein an upper surface of the seal material is parallel with an upper surface of the semiconductor chip.

2. The semiconductor chip package for an image sensor according to claim 1
wherein the transparent seal material is one selected from the group consisting of silicon, epoxy resin and acryl resin.

3. A method of packaging image sensor comprising:
(a) mounting a semiconductor chip for image sensor in a groove of a base member to attach;
(b) electrically connecting the semiconductor chip with a lead formed through the base member using a conductive connecting member;
(c) dropping a transparent seal material on an upper surface of the semiconductor chip;
(d) applying high-speed rotation force on a surface of the seal material so that the dropped seal material is filled up in the groove to be in parallel with the semiconductor chip; and
(e) curing the seal material.

4. The method according to claim 3
wherein the transparent seal material is one selected from the group consisting of silicon, epoxy resin and acryl resin.

5. A semiconductor chip package for an image sensor comprising:
a substrate formed a predetermined circuit pattern therein;
a semiconductor, chip for an image sensor mounted on the substrate;
a conductive connecting member for electric connection between the substrate and the semiconductor chip; and
a transparent seal material integrated on an upper portion of the substrate for wrapping and sealing the semiconductor chip for image sensor and the conductive connecting member, wherein an upper surface of the seal material is parallel with an upper surface of the semiconductor chip.

6. The method according to claim 5
wherein the transparent seal material is one selected from the group consisting of silicon, epoxy resin and acryl resin.

7. A method of packaging image sensor comprising:
(a) mounting a semiconductor chip for image sensor on a substrate formed a predetermined circuit pattern to attach;
(b) electrically connecting the semiconductor chip with the substrate using a conductive connecting member;
(c) applying an inner seal material for wrapping all around the semiconductor chip and an exterior of the conductive connecting member;
(d) dropping a transparent seal material on an upper surface of the image sensor chip;
(e) applying high-speed rotation force on a surface of the seal material so that the dropped seal material is filled up in the inner seal material to be in parallel with the image sensor chip; and
(f) curing the inner seal material and the seal material therein.

8. The semiconductor chip package for an image sensor according to claim 7
wherein the transparent seal material is one selected from the group consisting of silicon, epoxy resin and acryl resin.
